(19) United States
(12) Patent Application Publication
(10) Pub. No.: US 2019/0371092 A1
(43) Pub. Date: Dec. 5, 2019

(54) Method and Control Unit for Storing Error Information of a Vehicle in at Least One Vehicle Component of the Vehicle, Vehicle Component Unit Having a Memory Device, and Method for Producing a Vehicle Component Unit

(71) Applicant: Robert Bosch GmbH, Stuttgart (DE)

(72) Inventors: Florian Bessler, Stuttgart (DE); Holger Wuest, Stuttgart (DE); Peter Bartel, Eggenstein-Leopoldshafen (DE)

(21) Appl. No.: 16/476,175

(22) PCT Filed: Jan. 19, 2018
(86) PCT No.: PCT/EP2018/051265

§ 371 Date: Jul. 5, 2019

(30) Foreign Application Priority Data
Feb. 21, 2017 (DE) 10 2017 202 742.8

(51) Int. Cl. G07C 5/08; B60R 16/023; G06F 11/07

(52) U.S. Cl. CPC G07C 5/0808; B60R 16/0234; G07C 5/0816; G07C 5/085; G06F 11/0739

(57) ABSTRACT

The disclosure relates to a method for storing error information of a vehicle in at least one vehicle component of the vehicle. The method comprises at least one reading-in step and one providing step. In the reading-in step, an error signal is read in, which represents at least one provided piece of error information about at least one vehicle component. In the providing step, a memory signal is provided by using the error signal, which memory signal is designed to store the at least one piece of error information in a memory device of the vehicle component.

### PRIOR ART

The approach is based on a device or a method of the generic type of the independent claims. The subject matter of the present approach is also a computer program.

Before an old part repair process for vehicle components, the vehicle components are subjected to diagnostics and subsequently repaired for renewed use in accordance with a diagnostic result.

DE 10 2007 035 351 A1 describes a method for authenticating vehicle parts in a motor vehicle by reading out and evaluating stored manufacturer information in RFID tags in the vehicle parts.

### DISCLOSURE OF THE INVENTION

Against this background, with the approach presented here a method is presented for storing fault information of a vehicle in at least one vehicle component of the vehicle, also a control device which uses this method, as well as a corresponding computer program and furthermore a vehicle component unit with a memory device and finally a method for producing a vehicle component unit as claimed in the main claims. The measures specified in the dependent claims make possible advantageous developments and improvements of the method disclosed in the independent claim.

The advantages which can be achieved with the presented approach is that an old part repair process, in particular a preceding diagnostic process or testing process of vehicle components by means of a method presented here and a corresponding control device, can be significantly simplified and shortened.

A method for storing fault information of a vehicle in at least one vehicle component of the vehicle is presented. The method comprises at least one reading-in step and one providing step. In the reading-in step a fault signal which represents at least one provided fault information item about at least one vehicle component of the vehicle is read in. In the providing step, a memory signal which is designed to store the at least one fault information item in a memory device of the vehicle component is provided using the fault signal.

This method can be implemented, for example, in software or hardware or in a mixed form of software and hardware, for example in a control device.

The fault signal can represent, for example, fault information which is provided by a sensor or an fault memory of the vehicle.

Such a method serves to simplify an old part repair process, such that the vehicle component which is tested or is to be tested can provide, by means of the method presented here, at least one stored fault information item about the vehicle component or a further vehicle component. A test process and/or old part repair process of individual vehicle components can accordingly be adapted, for example shortened, as a function of the fault information which is respectively also supplied. The described old part repair process can also be referred to as a reman process, from the word remanufacturing.

In the providing step, it is possible to make available the memory signal which is designed to store the fault information in only the memory device of the vehicle component, but it is also possible to provide the memory signal which is designed to store the fault information in at least one further memory device of at least one further vehicle component, in order to store the fault information in all of the memory devices, present in the vehicle, of the vehicle components. If the fault information is stored only in the affected vehicle component, this can make possible an individual fault memory about fault information of this vehicle component. If the fault information is stored in a plurality of vehicle components or in all the relevant vehicle components, each vehicle component can provide an extensive overview over a multiplicity of fault information items of a plurality of vehicle components of the vehicle.

In order to be able to make available this extensive overview of fault information items of a plurality of vehicle components or of all the vehicle components of the vehicle, it is already possible in the reading-in step to read in the at least one fault signal which represents the fault information about the vehicle component and/or about at least one further vehicle component or about all the vehicle components of the vehicle.

In the reading-in step, it is possible to read in the fault signal which comprises, as the provided fault information, wear information and/or damage information and/or accident information and/or repair information and/or fault memory information about at least the vehicle component. Information of this type can supply important state information about the vehicle component/components.

In order to permit currentless storage and provision of the fault information in the memory device, in the providing step it is possible to provide the memory signal which is designed to store the at least one fault information item in the at least one memory device which is constructed as an RFID device. The RFID device can be an RFID transponder which can be made very small and can be secured well to the vehicle component.

It is also advantageous if in the providing step the memory signal, which is designed to store the fault information together with a time stamp in the at least one memory device, is provided. The time stamp can represent here, for example, a point in time at which the sensor has sensed the read-in fault information. Such a time stamp can provide information about a time profile of fault information of the vehicle. For example, fault information just before or at the moment of vehicle failure are particularly relevant for the old part repair process.

The approach presented here also provides a control device which is configured to execute, actuate and/or implement the steps of a variant of a method presented here in corresponding devices. The control device can be capable of being arranged in the vehicle. In this context, such a control device may be capable of being integrated, for example, into an already existing further control device of the vehicle. This embodiment variant of the approach in the form of a control device can also permit the object on which the approach is based to be achieved quickly and efficiently.

For this purpose, the control device can have at least one computing unit for processing signals or data, at least one memory unit for storing signals or data, at least one interface to a sensor or an actuator for reading in sensor signals from the sensor or for outputting control signals to the actuator and/or at least one communication interface for reading in or outputting data which are embedded in a communication protocol. The computing unit can be, for example, a signal processor, a microcontroller or the like, wherein the memory unit can be a flash memory, an EPROM or a magnetic memory unit. The communication interface can be designed to read in or output data in wireless fashion and/or line-bound fashion, wherein a communication interface which can read in or output line-bound data can read these data, for example, electrically or optically from a corresponding data transmission line or can output said data into a corresponding data transmission line.

A control device can be understood here to be an electrical device which processes sensor signals and outputs control signals and/or data signals as a function thereof. The control device can have an interface which can be embodied as hardware and/or software. In the case of a hardware embodiment, the interfaces can be, for example, part of a so-called system ASIC which contains a wide variety of functions of the control device. However, it is also possible for the interfaces to be separate integrated circuits or to be composed at least partially of discrete components. In the case of a software embodiment, the interfaces can be software modules which are present, for example, in a microcontroller in addition to other software modules.

In one advantageous refinement, the control device controls a memory signal. For this purpose, the control device can access, for example, sensor signals such as at least one fault signal. The actuation is carried out by means of actuators such as a reading-in device and a providing device.

A control device can be understood here to be an electrical device which processes sensor signals and outputs control signals and/or data signals as a function thereof. The sensor signals can be, for example, signals of a sensor of a motor vehicle or of a sensor which is installed in a motor vehicle. The sensor signals can therefore be signals of a gas sensor or of a lambda probe, of a pressure sensor which is installed, for example, in a bumper, or of an acceleration sensor, for example of an ESP sensor. The control signals and/or data signals can be signals which are transmitted to a control unit, for example a brake control device or engine control device. On the basis of these signals, the control unit can then decide whether, in the case of a malfunction of the tested sensor, for example a warning signal is output and/or an emergency running program which actuates specific units such as e.g. brake actuators in the motor vehicle, is activated, and/or specific units of the motor vehicle are deactivated, in order thereby to bring about a safe operating state.

A computer program product or computer program is also advantageous with program code which can be stored in a machine-readable carrier or storage medium such as a semiconductor memory, a hard disk memory or an optical memory and e.g. used to carry out, implement and/or actuate the steps of the method according to the embodiments described above, in particular if the program product or program is executed on a computer or a device.

A vehicle component unit has one of the described vehicle components and a memory device which is designed to store at least the one fault information item provided by the memory signal of the presented control device.

Such a vehicle component unit can advantageously store and provide at least one fault information item which can be helpful for an old part repair process of the vehicle component. The memory device of the vehicle component can advantageously be constructed as an RFID device. The memory device can be non-detachably fastened to the vehicle component.

The vehicle component of such a vehicle component unit can be an E-machine, that is to say an electric machine such as an electric motor, in particular a traction drive. However, the vehicle component can also be a generator and/or a dynamo and/or a battery and/or an inverter for a vehicle.

A method for producing one of the presented vehicle component units comprises at least the following steps:

providing the vehicle component of the vehicle; and

fastening the memory device to the vehicle component.

Such a production method can also be used to implement the advantages already presented by means of the approach.

Exemplary embodiments of the approach presented here are illustrated in the drawings and explained in more detail in the following description. In the drawings:

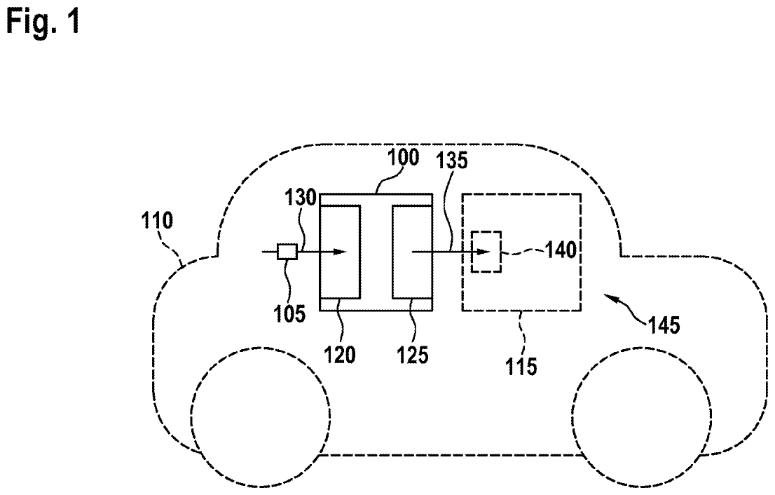

FIG. 1 shows a block diagram of a control device for storing fault information of a vehicle in at least one vehicle component of the vehicle according to an exemplary embodiment;

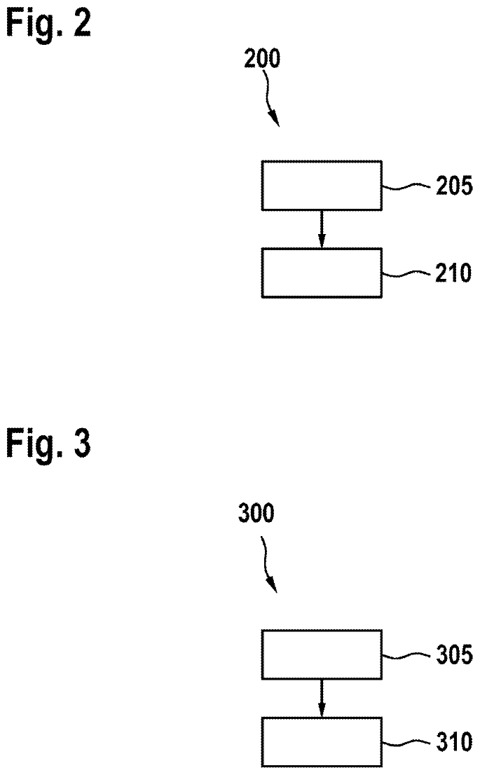

FIG. 2 shows a flow chart of a method for storing fault information of a vehicle in at least one vehicle component of the vehicle according to an exemplary embodiment; and

FIG. 3 shows a flow chart of a method for manufacturing a vehicle component unit according to an exemplary embodiment.

In the following description of favorable exemplary embodiments of the present approach, identical or similar reference signs are used for the elements which are illustrated in the various figures and act similarly, with a repeated description of these elements being dispensed with.

FIG. 1 shows a block circuit diagram of a control device 100 for storing fault information 105 of a vehicle 110 in at least one vehicle component 115 of the vehicle 110 according to an exemplary embodiment.

The control device 100 has, according to this exemplary embodiment, a reading-in device 120 and a providing device 125. The reading-in device 120 is designed to read in at least one fault signal 130 which represents at least one provided fault information item 105 about at least one vehicle component 115 of the vehicle 110. According to this exemplary embodiment, the reading-in device 120 is designed to read in the fault signal 130 in which the fault information 105 represents fault information 105 about the vehicle component 115 illustrated here. According to one alternative exemplary embodiment, the reading-in device 120 is designed to read in the fault signal 130 in which the fault information 105 additionally or alternatively represents at least one fault information item about at least one further vehicle component of the vehicle 110.

The providing device 125 is designed to use the fault signal 130 to provide a memory signal 135 which is designed to store the at least one fault information item 105 in a memory device 140 of the vehicle component 115. The providing device 125 is designed to output the memory signal 135 via a suitable interface, for example in a wireless fashion or line-bound fashion.

According to this exemplary embodiment, the control device 100 is incorporated in the vehicle 110. The vehicle component 115 is part of a vehicle component unit 145 which comprises at least the memory device 140 which is fastened in an optionally non-detachable fashion to the vehicle component 115. According to this exemplary embodiment, the vehicle component 115 is an E-machine of the vehicle 110 which is constructed as an electric vehicle. The memory device 140 of the E-machine is constructed as an RFID transponder. The fault information 105 comprises, according to this exemplary embodiment, at least one wear information item about the E-machine and a time stamp. According to this exemplary embodiment, the fault signal 130 is provided by a sensor of the vehicle 110.

The memory device 140 of the vehicle component unit 145 is designed to store the fault information 105 provided by the memory signal 135 of the control device 100.

In the text which follows, details of the control device 100 are described once more in more detail with reference to exemplary embodiments:

An RFID technology, that is to say a Radio Frequency IDentification Technology, used according to one exemplary embodiment permits storage, transmission and reading out of digitally stored information. In contrast to known control devices which use this RFID technology to attach product information to products and read at where necessary, the control device 100 presented here permits fault information 105 which arises in the course of a life cycle of a vehicle component 115 and which is about at least the vehicle component 115 to be stored in the vehicle component 115 itself in order to provide this fault information 105 for reading out for a reman process.

In other words, for example by using the control device 100, RFID labeling of components in the form of at least the vehicle component 115 is made possible for fault analysis for simplified diagnostics in the reman process. The approach described by means of the control device 100 makes it possible to read out information about possible damage, wear of individual components in the vehicle 110 and additional information from the vehicle 110 at the end of its service life, from a fault memory in the form of the memory device 140. Until now, RFID has been used to store information about a component or a product when it is installed and/or sold. However, the approach described here describes a system which stores the information required for a more efficient and simplified reman process during operation and above all also at a moment of a vehicle repair, in the original part in the form of the vehicle component 115. This stored fault information 105 can then be read out by means of RFID during a repair.

Components of the approach are accordingly, according to one exemplary embodiment, an RFID memory component in the form of the memory device 140 in the original part or the vehicle component 115 without a separate or integrated control device in combination with the control device 100 or a control device function in the vehicle 110, which device and function transmits the relevant fault information 105, also referred to as fault messages, to the control device 140 during the operation for the purpose of storage. When the vehicle 110 is broken up after the end of the service life and the defective vehicle component 115 is transferred into the reman process, the reman process can be configured more efficiently by means of the information stored in the memory device 140. In this context, fault information 105 from just before and/or from the moment of the failure of the vehicle 110 or fault information 105 which relates to the special events such as accidents, e.g. triggered air bags, is of particular interest. With this fault information 105, diagnostic steps in the reman process and decisions about various recycling scenarios can be facilitated.

Two examples as to how most recently stored fault information 105 in the machine can influence the reman process of the E-machine follow:

In the first example, a fault information item 105 which has been most recently stored in chronological terms indicates that an air bag of the vehicle 110 has been triggered. This fault information 105 suggests a high probability of shaking of the E-machine and makes it possible to infer that laborious checking is necessary since the E-machine may be damaged.

In the second example, a fault information item 105 which has been stored most recently in chronological terms indicates that a recall has taken place because of a catalytic converter problem, and in this case the E-machine is not affected. Accordingly, only a small functional check of the E-machine is sufficient.

This approach is also to be considered against the background of increasing electrification of the vehicle 110. In future, various types of sensors will indicate with ever greater precision what kind of problem has occurred when and at what point in the vehicle 110 and this information can advantageously be stored by the control device 100 in the vehicle components 110.

Evidence of the approach presented here can be obtained by means of the abovementioned combination of an RFID memory component with a corresponding control device function for transmitting fault information 105 to the RFID memory component and additionally about the communication about said component and function with one another. Furthermore, stored data about fault messages which are transmitted by the control device 100 in the memory device 140 can serve as evidence.

FIG. 2 shows a flow chart of a method 200 for storing fault information of a vehicle in at least one vehicle component of the vehicle according to an exemplary embodiment. This may involve a method 200 which can be executed by the control device described in FIG. 1.

The method 200 comprises at least one reading-in step 205 and one providing step 210. In the reading-in step 205, a fault signal is read in which represents at least one provided fault information item about at least one vehicle component of the vehicle. In the providing step 210, the fault signal is used to provide a memory signal which is designed to store the at least one fault information item in a memory device of the vehicle component.

According to this exemplary embodiment, in the reading-in step 205 the at least one fault signal which represents the fault information about the vehicle component and/or about at least one further vehicle component is read in.

According to this exemplary embodiment, in the reading-in step 205 the fault signal which comprises, as the provided fault information, wear information and/or damage information and/or accident information and/or repair information and/or fault memory information of the vehicle component is also read in.

In the providing step 210, according to this exemplary embodiment, the memory signal, which is designed to store the at least one fault information item in the at least one memory device which is constructed as an RFID device, is provided.

In the providing step 210, according to this exemplary embodiment, the memory signal, which is designed to store the fault information together with a time stamp in the memory device, is also provided.

The method steps presented here can be executed repeatedly and in a sequence other than that described.

FIG. 3 shows a flow chart of a method 300 for producing a vehicle component unit according to an exemplary embodiment. This can involve a method 300 for producing the vehicle component unit which is described in FIG. 1.

The method 300 has at least one providing step 305 and at least one fastening step 310. In the providing step 305, the vehicle component of the vehicle is provided. In the fastening step 310, the memory device is fastened to the vehicle component.

If an exemplary embodiment comprises an “and/or” link between a first feature and a second feature, this is to be understood as meaning that the exemplary embodiment according to one embodiment has both the first feature and the second feature, and the exemplary embodiment according to a further embodiment has only the first feature or only the second feature.

1. A method for storing fault information of a vehicle in at least one vehicle component of the vehicle, the method comprising:
reading in a fault signal configured to represent at least one fault information item about the at least one vehicle component of the vehicle; and
providing a memory signal using the fault signal, the memory signal being configured to store the at least one fault information item in a memory device of the at least one vehicle component.

2. The method as claimed in claim 1, the reading in further comprising:
reading in the fault signal configured to represent the at least one fault information item about at least one of (i) the at least one vehicle component and (ii) at least one further vehicle component.

3. The method as claimed in claim 1 the reading in further comprising:
reading in the fault signal configured to represent the at least one fault information item, the fault information item being at least one of (i) wear information, (ii) damage information, (iii) accident information, (iv) repair information, and (v) fault memory information of the at least one vehicle component.

4. The method as claimed in claim 1, the providing further comprising:
providing the memory signal configured store the at least one fault information item in the memory device, the memory device being constructed as an RFID device.

5. The method as claimed in claim 1, the providing further comprising:
providing the memory signal configured store the at least one fault information item together with a time stamp in the memory device.

6. A control device for storing fault information of a vehicle in at least one vehicle component of the vehicle, the control device configured to:
read in a fault signal configured to represent at least one fault information item about the at least one vehicle component of the vehicle; and
provide a memory signal using the fault signal, the memory signal being configured to store the at least one fault information item in a memory device of the at least one vehicle component.

7. The control device according to claim 6, wherein the control device is configured to execute a computer program.

8. The control device according to claim 7, wherein the computer program is stored on a non-transitory machine-readable storage medium.

9. The control device according to claim 6, wherein the control device is configured to provide the memory signal to a vehicle component unit comprising:
the at least one vehicle component; and
the memory device configured to store the at least the one fault information item provided by the memory signal.

10. The control device according to claim 6, wherein the memory device is constructed as an RFID device.

11. The control device according to claim 6, wherein the memory device is non-detachably fastened to the at least one vehicle component.

12. The control device according to claim 6, wherein the at least one vehicle component is an electric machine.

13. The control device according to claim 6, wherein the at least one vehicle component is at least one of a generator, a dynamo, a battery, and an inverter.

14. A method for producing a vehicle component unit having (i) at least one vehicle component of a vehicle and (ii) a memory device configured to store at least one fault information item about the at least one vehicle component, which is provided by a memory signal from a control device, the control device being configured to read in a fault signal configured to represent the at least one fault information item and provide the memory signal to the at least one vehicle component unit using the fault signal, the method comprising:
providing the at least one vehicle component of the vehicle; and
fastening the memory device to the at least one vehicle component.

15. The control device according to claim 12, wherein the electric machine is a traction drive.
